(19) United States
(12) Patent Application Publication
(10) Pub. No.: US 2007/0150602 A1
(43) Pub. Date: Jun. 28, 2007

(54) Distributed and Replicated Sessions on Computing Grids

(76) Inventors: Peter Yared, San Francisco, CA (US); Jeffrey B. Norton, Pleasanton, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/538,692

(22) Filed: Oct. 4, 2006

Related U.S. Application Data
(60) Provisional application No. 60/723,905, filed on Oct. 4, 2005.

(51) Int. Cl. G06F 15/16

(52) U.S. Cl. 709/227

(57) ABSTRACT

Distributed and replicated sessions are implemented in a grid architecture. A session including conversational state is stored at a server in the grid. An incoming request is directed to a server via a load balancing mechanism. When a server receives an incoming request, it either a) retrieves the session from the server that currently holds the state, or b) forwards the request to the server that currently holds the session. Each server maintains the session for the requests that it has serviced until relieved of this responsibility by another server. A server holding a session is relieved of responsibility for the state when another server retrieves the session. In one aspect of the invention, each session is replicated among a number of servers, so as to provide additional redundancy and thereby avoid having any single server as a single point of failure for the session which it maintains.

### CROSS-REFERENCE TO RELATED APPLICATIONS

The present invention claims priority from U.S. Provisional Patent Application Ser. No. 60/723,905, for “Distributed and Replicated Sessions on Computing Grids,” filed Oct. 4, 2005, the disclosure of which is incorporated herein by reference.

The present invention is related to U.S. Utility patent application Ser. No. 11/396,026, for “Framework for Service-Oriented Applications,” filed Mar. 31, 2006, the disclosure of which is incorporated herein by reference.

### FIELD OF THE INVENTION

This invention relates generally to infrastructure software for computing grids, and more specifically to an infrastructure for implementing distributed and replicated sessions on computing grids.

### BACKGROUND OF THE INVENTION

Web-based applications are commonly implemented using a web browser through which the user issues requests and a server which processes those requests. Communication between browser (also referred to herein as “client”) and server takes place via HTTP or by some other protocol, according to well known techniques.

Most such applications are conversational applications that involve multiple requests issued by the user in succession, in order to complete an operation. It is useful, therefore, to preserve session state from one request to the next, so that a meaningful multi-step interaction can take place. Additionally, it is useful to uniquely identify each user transaction or conversation so that these interactions can be properly tracked, for example when more than one user is interacting with the server at the same time.

In a single-server architecture, sessions may be maintained by the server in memory or stored by the server on local disk or in another medium accessible to the server.

In distributed architectures, there are multiple servers with routing hardware and software running between the client and server machines to direct each incoming client request to one of the servers. In such an architecture, a mechanism is required to store sessions and make them available when needed for the next client request.

One state management mechanism is to use a router that can remember which server last serviced a particular user conversation and send subsequent requests for the same conversation to the same server. In such an implementation, a single server serves each conversation. This type of router is called a sticky router. Two problems with this approach are: 1) a single server may become a bottleneck if the conversations assigned to it become active simultaneously; and 2) the type of router that can perform this redirection is relatively expensive and slow as it must partially process the request in order to determine which server should receive it.

Another approach is to use a simple layer 3 router that sends requests to the least loaded server at the time of the request. Software on the server finds and retrieves a session from either a central store, or from the server on which the session is maintained. The session can then be passed to the server handling the new request. Such an approach introduces significant additional overhead, since session state has to be located and passed from one entity to another before a request can be serviced.

Specifically, such an approach requires the server receiving the request to find the server holding the session. Some systems attempt to find the server holding the session by broadcasting a request to all servers, polling individual servers, or storing information in a central registry. All of these solutions require additional network bandwidth, creating additional network load that grows in proportion to the number of servers. The system as a whole thus becomes less efficient as it becomes larger. In addition, any form of central registry introduces a bottleneck resulting in an upper bound on throughput, and a potential single point of failure.

Another approach involves storing sessions on all servers. Such a system introduces additional overhead, as sessions must be sent to all servers before a reply is sent back to the client.

In any system, failures can occur that render a server unable to function. Specifically, if a session is stored at one server, even in a distributed system, failure of that server would cause any conversations processed by that server to fail. State replication can alleviate this problem, by making sessions available at more than one server. However, such an approach tends to be expensive and time-consuming.

What is needed, therefore, is a technique for preserving session state in a multiple-server architecture that avoids the problems and limitations set forth above, and that operates reliably and efficiently. What is further needed is a state preservation technique that does not introduce undue network load, and that avoids or minimizes bottlenecks and single points of failure. What is further needed is a state preservation technique that can operate in both distributed and replicated state architectures. What is further needed is a technique that allows servers to be added or removed from the system without restarting the system and without the need for special configuration of any server to be able to access any other server in the system. What is further needed is a system that quickly adapts to failures so that one failure does not leave another server as a single point of failure or bottleneck.

### SUMMARY

According to the present invention, sessions are stored (held) at a server. When an incoming request is received, a router (such as a level 3 router) directs the request to a server based on a determination as to which server is the least loaded or based on some other distribution algorithm. When a server receives an incoming request directed to it by the router, the server either a) retrieves the session from the server that currently holds the session, or b) forwards the request to the server that currently holds the session. The decision as to which approach to take can be made by the administrator of the system or it can be made by the system based on the relative amount of time needed to perform a) and b).

Each server maintains the sessions for the requests that it has serviced until relieved of this responsibility by another server. A server holding a session is relieved of responsibility for the session when another server retrieves the session. No central store of sessions is needed. By avoiding the need for a central store of sessions, the present invention avoids a potential bottleneck or single point of failure which potentially can render the system as a whole inoperative.

The present invention provides an efficient mechanism for determining which server currently holds a session. In one embodiment, the IP address of the server holding the session is sent to the client as part of a response to a content request. The IP address is encoded and stored in a cookie at the client. When making a subsequent request, the client retrieves the encoded IP address from the locally stored cookie and includes the encoded IP address in the subsequent request. In this manner, all subsequent requests can contain within them information that identifies the IP address of the server holding the session.

Whichever server receives the subsequent request (server A) can then make a single request to retrieve the session from the identified session-holding server (server B), or it can forward the request directly to server B. The choice of which way to handle the request can be conditioned based on efficiency parameters such as session size (the amount of data being stored in order to maintain the session) and request size (the amount of data in the new request from the client).

For example, if the session size is large and/or the request size is small, it may be more efficient to forward the request to server B. In some situations (as may be required based on network configuration), the reply to the client must be sent from the same server that initially received the request. In such situations the extra cost of redirecting the reply back through server A must be factored in.

If, on the other hand, the session size is small and/or the request size is large, it may be more efficient to retrieve the session from server B. The process of retrieving the session relieves server B from its responsibility, so that server A now becomes the session-holding server for future requests.

In one embodiment, the session is replicated among a number of servers, so as to provide additional redundancy and thereby avoid having any single server as a single point of failure for the session which it maintains. In this embodiment a server replying to a client request saves the session on one or more other servers after it processes the request but before replying to the client. The server-identifying data sent to the client for cookie storage contains additional data that specifies the alternate server(s) on which the session is stored. The client will transmit this additional data as part of subsequent requests. Then, whichever server receives the subsequent request (server A) can attempt to retrieve the session from the identified primary session-holding server (server B) or to forward the request to server B. If server B is unavailable or unable to provide the session or receive the forwarded request, server A can attempt similar operations with an alternate session-holding server (server C) identified in the request from the client. In one embodiment, a primary server and a designated priority or sequence of alternates is provided. In other embodiments, two or more servers are designated without an indication as to a primary; the determination of which server to use can be made based on load, proximity, or other factors. The number of servers on which the session is saved can be configured to provide for the desired level of redundancy.

Because this approach requires no special hardware or software and uses only standard HTTP capabilities, it can be employed on a wide variety of systems with little cost. In one embodiment, it is implemented using the Apache web server, although one skilled in the art will recognize that the invention can be implemented using many other types of servers.

The present invention avoids the limitations of prior art systems. Specifically, when a request is forwarded to another server using the techniques of the present invention, the additional time and hardware complexity of a sticky router are avoided. Furthermore, when retrieving a session from a server that holds it, the present invention avoids the need to retrieve such information from a central registry. The cost of retrieving a session from a peer remains constant with respect to the number of servers in the system, unlike prior art systems wherein the cost increases linearly with the number of servers in the system.

Specifically, the cost of getting the session is the sum of the cost to locate the session and the cost to transmit the session. The cost to transmit the session varies according to the size of the session and is invariant with respect to the number of servers in the system. Thus for any given request it is constant. The present invention virtually eliminates the cost to locate the session, as opposed to prior art systems where the locate cost increases linearly with the number of servers in the system.

### BRIEF DESCRIPTION OF THE DRAWINGS

FIG. 1 is a block diagram depicting an architecture for practicing the present invention according to one embodiment.

FIG. 2 is a flowchart depicting a method of servicing a first request for a session in a distributed session architecture according to one embodiment.

FIG. 3 is a block diagram depicting a first request being serviced by a computing grid for a distributed session architecture according to one embodiment.

FIG. 4 is a flowchart depicting a method of servicing a subsequent request for a session in a distributed session architecture according to one embodiment.

FIG. 5 is a block diagram depicting a subsequent request being serviced by a computing grid for a distributed session architecture according to one embodiment.

FIG. 6 is a flowchart depicting a method of servicing a first request for a session in a replicated session architecture according to one embodiment.

FIG. 7 is a block diagram depicting a first request being serviced by a computing grid for a replicated session architecture according to one embodiment.

FIG. 8A is a flowchart depicting a method of servicing a subsequent request for a session in a replicated session architecture, where a server requests a session from another server, according to one embodiment.

FIG. 8B is a flowchart depicting a method of servicing a subsequent request for a session in a replicated session architecture, where a server forwards a request to another server, according to one embodiment.

FIG. 9 is a block diagram depicting a subsequent request being serviced by a computing grid for a replicated session architecture according to one embodiment.

FIG. 10 is a flowchart depicting a method of copying session data when a server becomes unavailable.

FIG. 11 is a block diagram depicting an example of the method of FIG. 10.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

In one embodiment, the present invention is implemented in a computing grid, as a mechanism for implementing distributed and replicated sessions on computing grids. For purposes of the following description, the term “grid” is defined as a cluster of machines. One skilled in the art will recognize that the present invention can be implemented in any multiple-server environment where it is desirable to preserve state information for a computing session.

The terms “session”, “state”, “conversational state”, “state data”, “state information”, and “session state” are used interchangeably in this patent application.

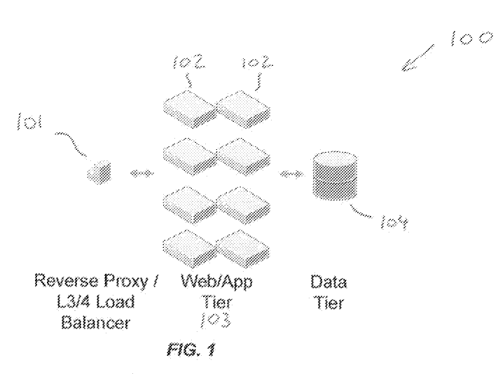

Referring now to FIG. 1, there is shown an example of a grid architecture for implementing the present invention. Load balancer 101 is a level three and/or level four load balancer that distributes requests among servers 102 in the web/application tier 103 of grid 100. In one embodiment, load balancer 101 includes a reverse proxy. A reverse proxy allows a single external IP address to be seen by clients while having many servers 102 that can handle requests from clients. The reverse-proxy functionality (which may be implemented, for example, by a server associated with load balancer 101) has a single IP address which all clients use; to the clients, it appears as though a single machine handles requests. The reverse proxy server then forwards the request to one of a plurality of servers 102, each having its own IP address. Servers 102 communicate with data tier 104 to obtain data based on application needs. Data tier 104 services application needs for data. In one embodiment, data tier 104 represents a data and foreign service tier that includes and/or interfaces with databases as well as foreign web services in it.

As will be described in more detail below, in one embodiment the present invention facilitates deployment of a grid-based architecture such as that shown in FIG. 1 to implement distributed sessions in an enterprise environment by providing a mechanism by which servers 102 (also referred to herein as “nodes”) can share sessions amongst themselves.

Distributed Sessions on Transaction Grids

In one embodiment, the present invention provides a mechanism for maintaining session data on a transaction grid using distributed sessions. With distributed sessions, sessions for a client (a shopping cart, for example) are stored, or held, in the memory of one of servers 102 in grid 100. Subsequent requests from that client are handled in one of two ways: either the request is directed to the server 102 where the session is held, or the session is transferred to the server 102 that received the request.

The choice of which way to handle the request can be conditioned based on efficiency parameters such as session size (the amount of data being stored in order to maintain a session) and request size (the amount of data in the new request from the client).

For example, if the session size is large and/or the request size is small, it may be more efficient to forward the request to server B. In some situations, as may be required by the network, the reply to the client must be sent from server A. In such situations the extra cost of redirecting the reply back through server A must be factored in.

If, on the other hand, the session size is small and/or the request size is large, it may be more efficient to retrieve the session from server B. The process of retrieving the session relieves server B from its responsibility, so that server A now becomes the session-holding server for future requests.

In one embodiment, threshold values are established to determine which of the two mechanisms is employed for a particular request. For example, a request is forwarded from server A to server B if the session size is larger than the request size and if the reply can then be sent from server B back to the client. If the reply must be redirected through the server A, then the expected reply size is factored in, so that the request is forwarded from server A to server B if the session size is larger than the sum of the request size plus the expected reply size. Expected reply size can be predicted based on discovered patterns or other factors, or can be roughly estimated at some fixed amount, such as for example 10 kilobytes.

When the server grid is initialized, it is not necessary for servers 102 to have any awareness of each other. In one embodiment, servers 102 are autonomous. They are registered with an L3/4 load balancer 101 so that load balancer 101 can route requests to various servers 102 in grid 100 according to well-known load-balancing techniques.

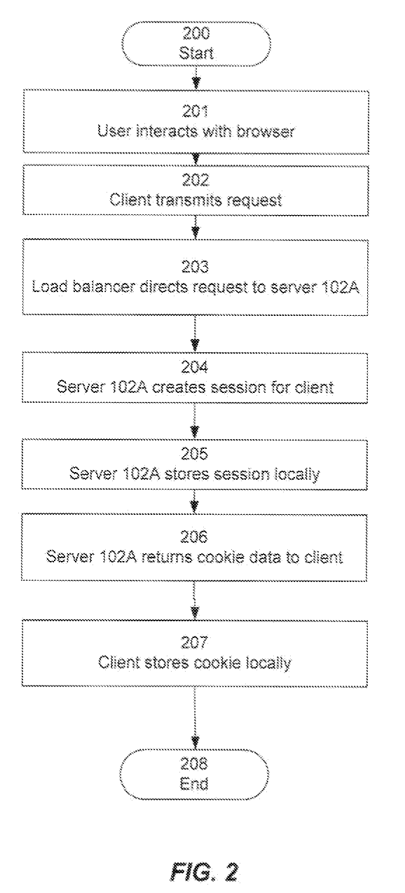

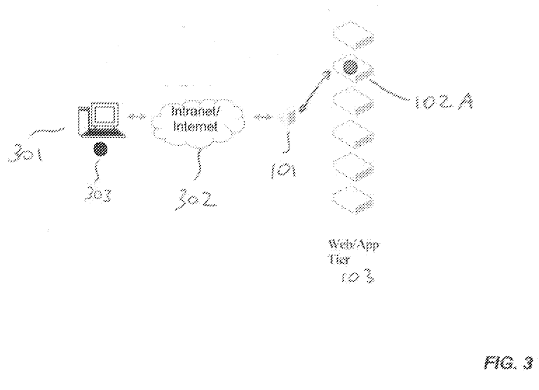

Referring now to FIG. 2, there is shown a flowchart depicting a method for servicing a first request from a client computer in a distributed session architecture according to one embodiment. Referring also to FIG. 3, there is shown a block diagram of a first request being serviced by grid 100.

A user interacts 201 with a browser running at client computer 301. Client computer 301 transmits 202 an HTTP request via the Internet 302. Load balancer 101 directs 203 the request to server 102A. The selection of which server 102A gets the request is based on well known load-balancing techniques. For example, load balancer 101 can select the least-loaded server, or it can use a round robin approach to selecting the next server in line, or it can use some other known technique.

The selected server 102A creates 204 a session for the client 301 and stores it 205 locally at server 102A. Server 102A returns data 206 to client 301 to be stored as a cookie 303 at client 301. Client 301 stores the cookie locally 207. The cookie data includes an opaque server identifier that enables other servers 102 in grid 100 to find server 102A that contains the session. In one embodiment, the opaque server identifier is a symmetrically encrypted IP address of server 102A containing the session.

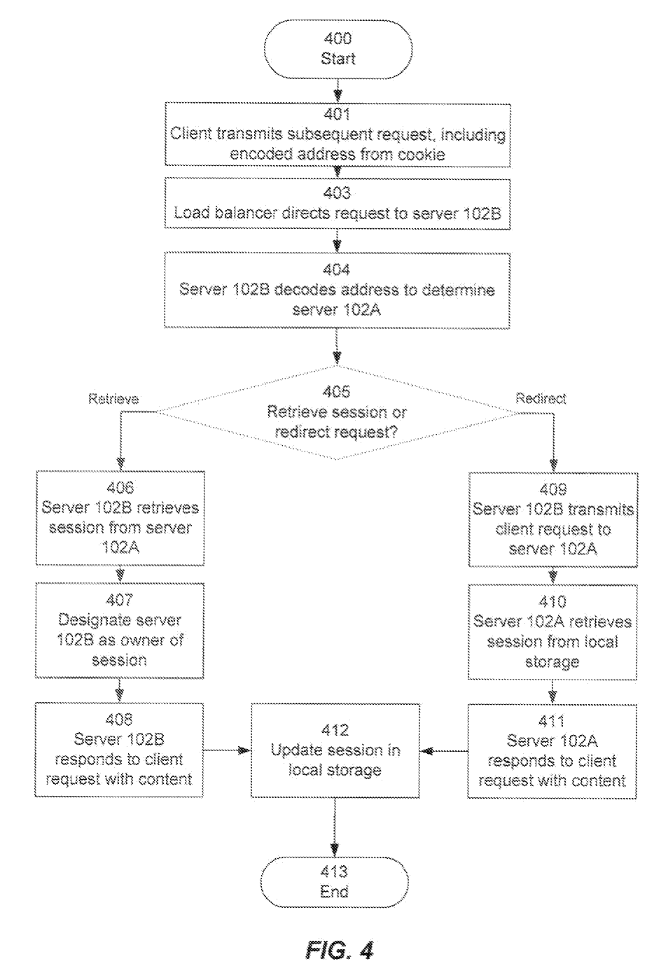

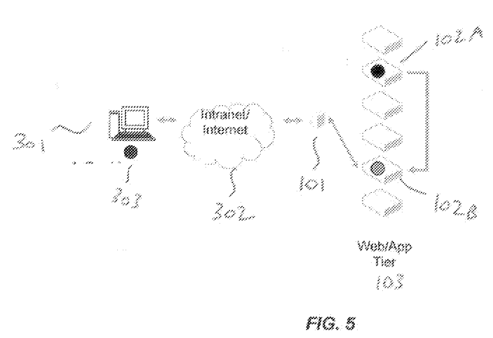

Referring now to FIG. 4, there is shown a flowchart depicting a method for servicing a subsequent request from client computer 301 according to one embodiment, where session information has previously been stored at one of servers 102 in grid 100 in a distributed session architecture. Referring also to FIG. 5, there is shown a block diagram of a subsequent request being serviced by grid 100.

Client computer 301 transmits 401 a subsequent HTTP request via the Internet 302. Load balancer 101 directs 403 the request to server 102B. As before, the selection of which server 102B gets the request is based on well known load-balancing techniques.

In one embodiment, the request from client computer 301 includes an encoded IP address for server 102A, obtained from cookie 303 and identifying server 102A as the place where the session has been stored. Server 102B decodes 404 this IP address to determine which server 102A contains the session.

A decision 405 is made whether to a) retrieve the session from server 102A or b) redirect the request to server 102A. In one embodiment, this decision 405 is made based on the size of the client request and/or the size of the session. The size of the request is known to server 102B; the size of the session can be stored in cookie 303 and passed to server 102B as part of the HTTP request so that server 102B can make decision 405.

If a) is selected, server 102B uses an HTTP Get request 406 to retrieve the session from server 102A. If the session should be secure within a network, server 102B can use HTTPS Get. Server 102B is then designated 407 as the owner of the session; it stores the session locally. In one embodiment, server 102A deletes the session from its local store once the session has been transferred to server 102B. Server 102B then responds 408 to the client request by providing the appropriate content to client computer 301 via the Internet 302, based on the session and based on the nature of the client request. Server 102B also includes, in the response, new data 506 to be stored as a cookie 504 at client 301. This new cookie data includes an opaque server identifier for server 102B, so that subsequent client requests can identify server 102B as holding the session. Server 102B updates 412 the session in its local store, based on the client request.

If, in 405, decision b) is made, server 102B transmits 409 the client request to server 102A. Server 102A retrieves 410 the session from its local store and remains the owner of the session. Server 102A then responds 411 to the client request by providing the appropriate content to client computer 301 via the Internet 302, based on the session and based on the nature of the client request. Server 102A updates 412 the session in its local store, based on the client request.

In one embodiment, a distributed session does not include a failure mechanism. If server 102A containing the session is no longer accessible, server 102B creates a new, empty session for client computer 301.

In another embodiment, alternate server(s) 102C can also hold the session. These alternate server(s) 102C can also be identified in cookie 504 so that their addresses are transmitted by client computer 301 when a request is made. Then, if server 102A containing the session is no longer accessible, server 102B can try alternate server(s) 102C. If any alternate server 102C is available, server 102B makes the decision in 405 and proceeds as discussed above.

Replicated Sessions on Transaction Grids

In one embodiment, the present invention provides a mechanism for maintaining session data on a transaction grid using replicated sessions. With replicated sessions, sessions for a client (a shopping cart, for example) are replicated among two or more servers 102 in grid 100. For replicated session support, it is desirable for servers 102 to have some initial awareness of each other in order to handle the first few requests, so that the session can be replicated from one server 102 to another 102. After some interactions have taken place, servers 102 can become aware of each other. In order to provide some initial awareness of other servers 102, each servers 102 is initialized with a list of known peers. Servers 102 are registered with load balancer 101 so that load balancer 101 can route requests to various servers 102 in grid 100 according to well-known load-balancing techniques.

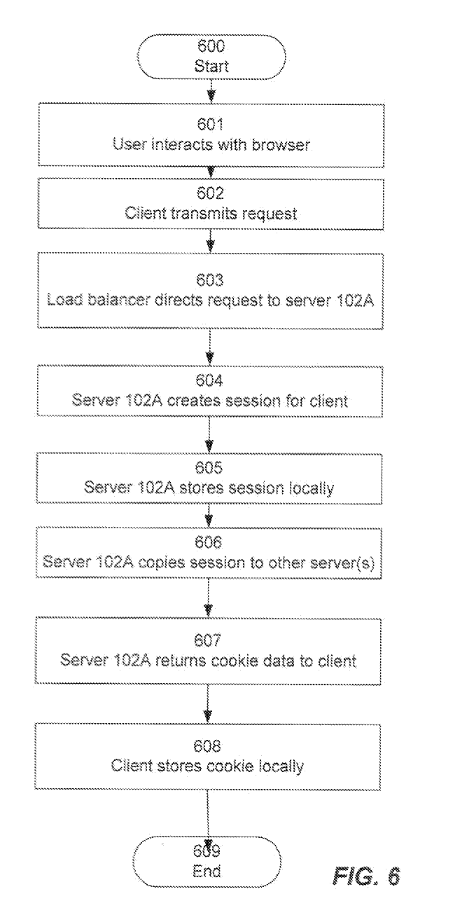

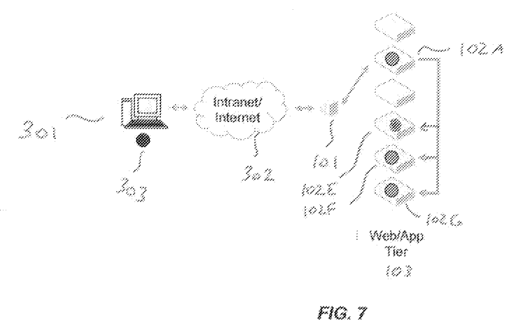

Referring now to FIG. 6, there is shown a flowchart depicting a method for servicing a first request from a client computer in a distributed session architecture according to one embodiment. Referring also to FIG. 7, there is shown a block diagram of a first request being serviced by grid 100.

A user interacts 601 with a browser running at client computer 301. Client computer 301 transmits 602 an HTTP request via the Internet 302. Load balancer 101 directs 603 the request to server 102A. The selection of which server 102A gets the request is based on well known load-balancing techniques. For example, load balancer 101 can select the least-loaded server, or it can use a round robin approach to selecting the next server in line, or it can use some other known technique.

The selected server 102A creates 604 a session for the client 301 and stores it 605 locally at server 102A. The selected server 102A then copies 606 the session to one or more other servers 102E, 102F, 102G (as specified in the application's configuration), for example using HTTP Post. If the session should be secure within a network, server 102A can use HTTPS Post.

Server 102A returns data 607 to client 301 to be stored as a cookie 303 at client 301. Client 301 stores the cookie locally 608. The cookie data includes opaque server identifiers that enable other servers 102 in grid 100 to find servers 102A, 102E, 102F, and/or 102G that contain a copy of the session. In one embodiment, each opaque server identifier is a symmetrically encrypted IP address of one of servers 102A, 102E, 102F or 102G containing the session.

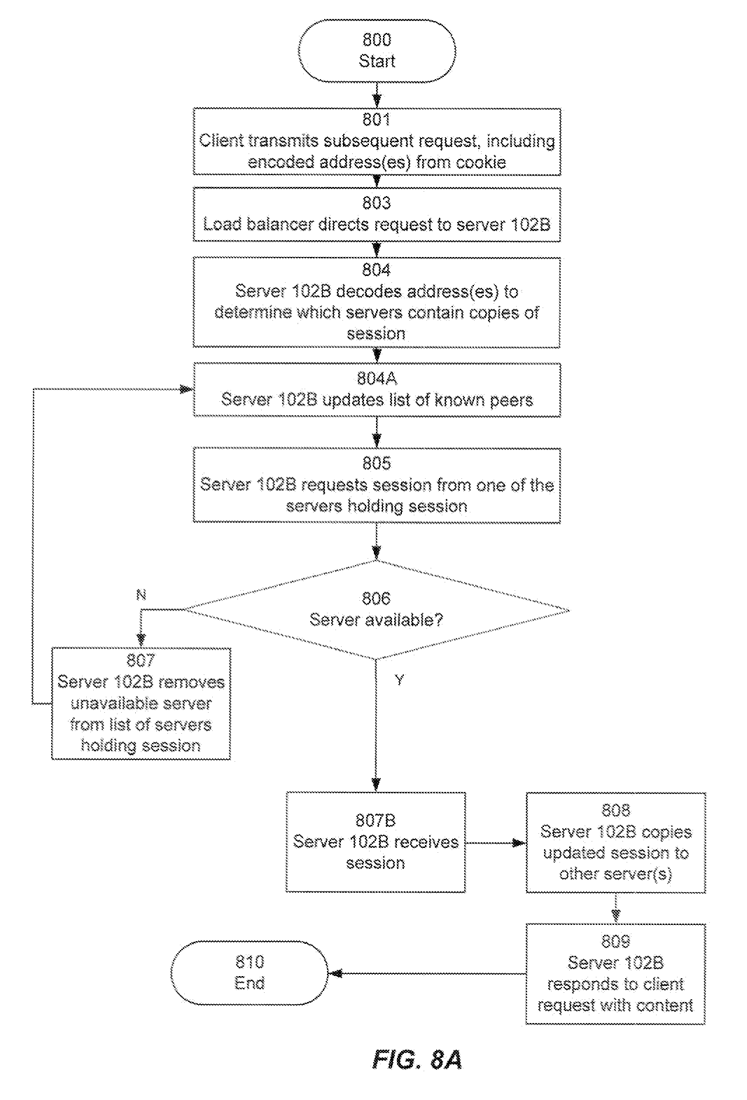

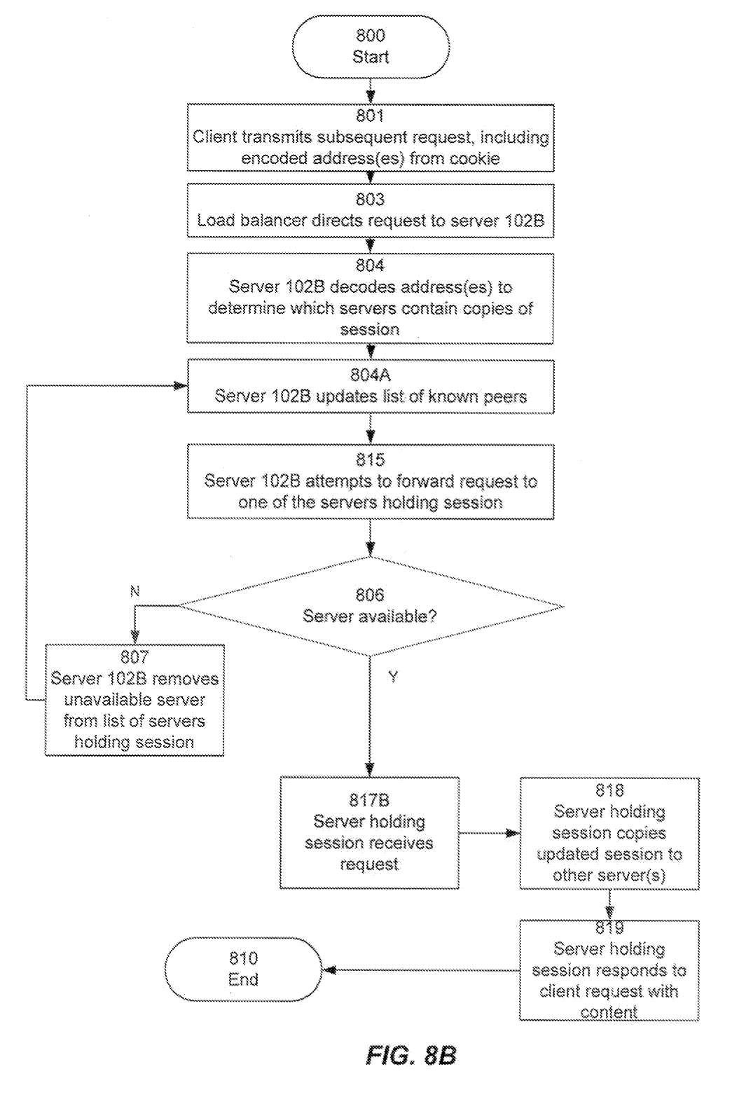

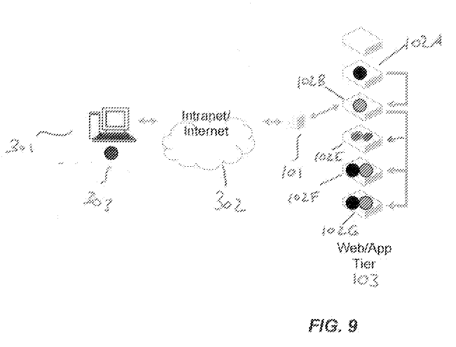

Referring now to FIG. 8A, there is shown a flowchart depicting a method for servicing a subsequent request from client computer 301 according to one embodiment, where a session has previously been stored at one of servers 102 in grid 100 in a replicated session architecture. Referring also to FIG. 9, there is shown a block diagram of a subsequent request being serviced by grid 100.

Client computer 301 transmits 801 a subsequent HTTP request via the Internet 302. Load balancer 101 directs 803 the request to server 102B. As before, the selection of which server 102B gets the request is based on well known load-balancing techniques.

In one embodiment, the request from client computer 301 includes a list of server(s) holding a copy of the session. In one embodiment, such list takes the form of one or more encoded IP address(es) for server(s) 102A, 102E, 102F, and/or 102G obtained from cookie 303. Server 102B decodes 804 these IP addresses to determine which servers contain copies of the session.

Server updates 804A its list of known peers based on the information from cookie 303. Server 102B then does an HTTP Get request 805 to retrieve the session from one of servers 102A, 102E, 102F, 102G that is holding the session. If a particular one of servers 102A, 102E, 102F, 102G is not available 806, server 102B removes 807 the unavailable server from the list of servers holding the session, and returns to step 804A.

Server receives 807B the session and copies 808 the updated session to one or more servers 102A, 102E, 102F, 102G (or some other designated combination of servers 102, as specified in the application's configuration) using an HTTP Post request. If the session should be secure within a network, server 102B can use HTTPS Post.

Server 102B then responds 809 to the client request by providing the appropriate content to client computer 301 via the Internet 302, based on the session and based on the nature of the client request. Server 102B also includes, in the response, new data 906 to be stored as a cookie 303 at client 301. This new cookie data includes one or more opaque server identifier(s) for servers 102 that now contain copies of the updated the session, so that subsequent client requests can identify such server(s) 102 as holding the session. In an alternative embodiment, step 809 can be performed before step 808. If the session should be secure within a network, server 102B can use HTTPS Get.

Referring now to FIG. 8B, there is shown a variation where it is determined that it is preferable to forward the request to one of servers 102A, 102E, 102F, 102G that is holding the session, instead of requesting the session one of servers 102A, 102E, 102F, 102G. Here, server 102B attempts 815 to forward the request to one of 102A, 102E, 102F, 102G. If the destination server is not available 806, server 102B removes 807 the unavailable server from its list of servers holding the session and returns to step 804A.

The server 102 holding the session receives 817B the request and copies 818 the updated session to one or more servers 102A, 102E, 102F, 102G (or some other designated combination of servers 102, as specified in the application's configuration) using an HTTP Post request. If the session should be secure within a network, the server can use HTTPS Post.

The server 102 holding the session then responds 819 to the client request by providing the appropriate content to client computer 301 via the Internet 302, based on the session and based on the nature of the client request. The server 102 also includes, in the response, new data 906 to be stored as a cookie 303 at client 301. This new cookie data includes one or more opaque server identifier(s) for servers 102 that now contain copies of the updated the session, so that subsequent client requests can identify such server(s) 102 as holding the session. In an alternative embodiment, step 819 can be performed before step 818. If the session should be secure within a network, the server can use HTTPS Get.

One advantage of a replicated session architecture is that the pool of available servers 102 is continually updated, so that the grid is able to deal with potential failures of individual nodes within the grid. Individual servers 102 maintain lists of available peer servers; these lists get updated, as indicated above, based on information from cookies 303 and based on servers 102 discovering that peers are unavailable or do not respond to requests. When a server 102 determines that a peer server 102 is unavailable, the first server 102 removes the unavailable server 102 from its list of available peer servers. In one embodiment, the list of available peer servers is saved on nonvolatile media (such as a hard disk), so that it can survive a server 102 restart.

When a new server 102 is added to grid 100, it is registered at load balancer 101, which starts to forward requests to it. The new server's 102 opaque server identifier gets embedded in user cookies 303 that are then submitted to other servers 102, causing these servers 102 to update their lists of peers to include the new server 102.

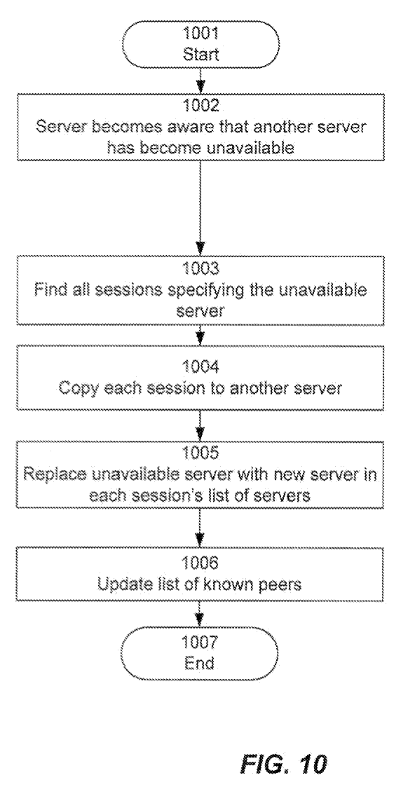

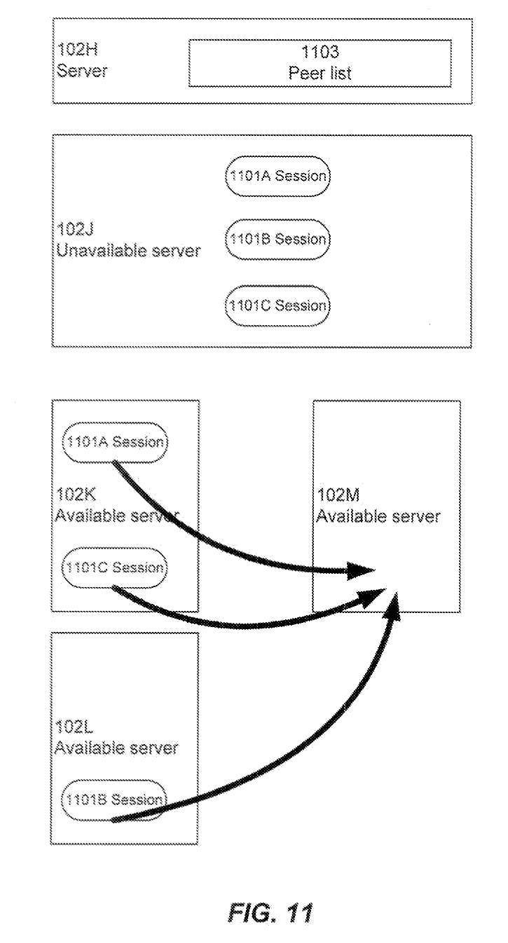

Referring now to FIGS. 10 and 11, there is shown a method of copying sessions to servers in response to the unavailability of a server 102J. A server 102H becomes aware 1002 that another server 102J has become unavailable. This may happen, for example, when server 102H attempts to request session data as in step 805, or it may happen as a result of periodic pinging by server 102H of other servers 102 (peers) to check availability.

A determination is made as to which sessions 1101A, 1101B, 1102C are stored at unavailable server 102J. For such session 1101A, 1101B, 1102C, a copy of the session is obtained from an available server (such as servers 102K and 102L), and the session is copied 1004 to an available server 102M to replace the copy at the unavailable server 102J. For each copied session 1101A, 1101B, 1102C, a list of servers 102 associated with the session is updated 1005 to indicate that the session is now available at server 102M instead of server 102J. Server's 102H peer list 1103, which lists available servers 102 is updated 1006; if appropriate, peer list 1103 is also updated at other servers 102.

In one embodiment, the present invention is implemented in the context of an Apache web server. A C++ module in the server implements distributed and replicated sessions using the state management techniques described herein. The C++ module communicates with a web runtime for implementing web-based computing, such as the ActiveGrid web runtime. Additional details for such a runtime can be found, for example, in related U.S. Utility patent application Ser. No. 11/396,026, for “Framework for Service-Oriented Applications,” filed Mar. 31, 2006, the disclosure of which is incorporated herein by reference.

In one embodiment, the present invention can be implemented in a Python module of the Apache web server or a Jython module of a Java web container such as Tomcat. In an alternate embodiment, the present invention can be implemented in a Python module of an Apache web server. Such an implementation facilitates direct integration into the web runtime so as to reduce communication overhead. Such an implementation could also be used in any Java web container or application server (Java EE). In a Java container, for example, it could be run within a Jython interpreter as part of the ActiveGrid web runtime.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of the above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium th can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

In one embodiment, the present invention is implemented as computer program code encoded on a medium such as a disk.

What is claimed is:

1. A method for maintaining session state information in a multiple server architecture, comprising:
receiving an initial request from a client;
directing the initial request to a first server within a plurality of servers;
creating a session for the client;
storing the client session at a storage device associated with the first server;
transmitting, to the client, a server identifier identifying the first server as the holder of the session;
receiving a subsequent request from the client, the subsequent request comprising the server identifier identifying the first server;
directing the subsequent request to a second server within a plurality of servers;
at the second server, reading the server identifier; and
responding to the request using the session stored at the server identified by the server identifier.

2. The method of claim 1, wherein responding to the request using the session stored at the server identified by the server identifier comprises:
the second server retrieving, from the server identified by the server identifier, the session.

3. The method of claim 2, further comprising:
storing the client session at a storage device associated with the second server; and
transmitting, to the client, a server identifier identifying the second server as the holder of the session.

4. The method of claim 1, wherein responding to the request using the session stored at the server identified by the server identifier comprises:
redirecting the subsequent request to the server identified by the server identifier.

5. The method of claim 1, wherein responding to the request using the session stored at the server identified by the server identifier comprises:
determining whether to retrieve the session from the server identified by the server identifier or to redirect the subsequent request to the server identified by the server identifier; and
performing the determined action.

6. The method of claim 5, wherein determining whether to retrieve or redirect comprises at least one of:
determining whether the session size exceeds the request size; and
determining whether the session size exceeds the sum of the request size and an expected reply size.

7. The method of claim 1, wherein:
directing the initial request to a first server within a plurality of servers comprises directing the initial request using a load balancing method based on at least one of network conditions and round robin allocation; and
directing the subsequent request to a second server within a plurality of servers comprises directing the subsequent request using a load balancing method based on at least one of network conditions and round robin allocation.

8. The method of claim 1, wherein the plurality of servers comprises a grid.

9. The method of claim 1, wherein transmitting the server identifier comprises transmitting a representation of the server identifier for storage at the client.

10. The method of claim 1, wherein transmitting the server identifier comprises transmitting a representation of the server identifier for storage in a cookie at the client.

11. The method of claim 1, wherein the server identifier comprises an encoded IP address.

12. A method for storing session state information in a multiple server architecture, comprising:
receiving an initial request from a client;
directing the initial request to a selected server within a plurality of servers;
creating a session for the client;
storing the client session at a storage device associated with the selected server;
transmitting, to the client, a server identifier identifying the selected server as the holder of the session.

13. The method of claim 12, wherein:
directing the initial request to a selected server within a plurality of servers comprises directing the initial request based on at least one of a load balancing method based on network conditions and a round robin allocation method.

14. The method of claim 12, wherein the plurality of servers comprises a grid.

15. The method of claim 12, wherein transmitting the server identifier comprises transmitting a representation of the server identifier for storage at the client.

16. The method of claim 12, wherein transmitting the server identifier comprises transmitting a representation of the server identifier for storage in a cookie at the client.

17. The method of claim 12, wherein the server identifier comprises an encoded IP address.

18. A method for retrieving session state information in a multiple server architecture, comprising:
receiving a request from a client, the request comprising a server identifier identifying a first server as a holder of the session;
directing the request to a second server;
at the second server, reading the server identifier; and
responding to the request using the session stored at the identified first server.

19. The method of claim 18, wherein responding to the request using session comprises:
the second server retrieving the session from the server identified by the server identifier.

20. The method of claim 19, further comprising:
storing the session at a storage device associated with the second server; and
transmitting, to the client, a server identifier identifying the second server as the holder of the session.

21. The method of claim 18, wherein responding to the request using the session stored at the identified first server comprises:
redirecting the request to the identified first server.

22. The method of claim 18, wherein responding to the request using the session stored at the identified first server comprises:
determining whether to retrieve the session from the identified first server or to redirect the subsequent request to the identified first server; and
performing the determined action.

23. The method of claim 22, wherein determining whether to retrieve or redirect comprises at least one of:
determining whether the session size exceeds the request size; and
determining whether the session size exceeds the sum of the request size and an expected reply size.

24. The method of claim 18, wherein:
directing the request to a second server comprises directing the request using at least one of a load balancing method based on network conditions and a round robin allocation.

25. The method of claim 18, wherein the first and second servers are part of a grid.

26. The method of claim 18, wherein the server identifier is derived from information stored at the client.

27. The method of claim 18, wherein the server identifier is derived from information in a cookie at the client.

28. The method of claim 18, wherein the server identifier comprises an encoded IP address.

29. A method for maintaining session state information in a multiple server architecture, comprising:
receiving an initial request from a client;
directing the initial request to a first server within a plurality of servers;
creating a session for the client;
storing the client session at a storage device associated with the first server;
storing a copy of the client session at at least one additional storage device associated with at least one additional server;
transmitting, to the client, a plurality of server identifiers, the server identifiers identifying the first server and the at least one additional server as the holders of the session;
receiving a subsequent request from the client, the subsequent request comprising the server identifiers identifying the first server and the at least one additional server;
directing the subsequent request to a second server within the plurality of servers;
at the second server, reading the server identifiers; and
responding to the request using the session stored at a server identified by one of the server identifiers.

30. The method of claim 29, wherein responding to the request using the stored session comprises:
the second server retrieving the session from one of the servers identified by the server identifiers.

31. The method of claim 30, further comprising:
storing the session at a storage device associated with the second server; and
storing, at at least one additional storage device associated with at least one additional server, a copy of the client session;
transmitting, to the client, server identifiers identifying the second server and the at least one additional server as the holders of the session.

32. The method of claim 29, wherein responding to the request using the session comprises:
redirecting the subsequent request to a server identified by one of the server identifiers.

33. The method of claim 29, wherein responding to the request using the stored session comprises:
determining whether to retrieve the session from a server identified by one of the server identifiers or to redirect the subsequent request to a server identified by one of the server identifiers; and
performing the determined action.

34. The method of claim 33, wherein determining whether to retrieve or redirect comprises at least one of:
determining whether the session size exceeds the request size; and
determining whether the session size exceeds the sum of the request size and an expected reply size.

35. The method of claim 29, wherein:
directing the initial request to a first server within a plurality of servers comprises directing the initial request using at least one of a load balancing method based on network conditions and a round robin allocation method; and
directing the subsequent request to a second server within a plurality of servers comprises directing the subsequent request using at least one of a load balancing method based on network conditions and a round robin allocation method.

36. The method of claim 29, wherein the plurality of servers comprises a grid.

37. The method of claim 29, wherein transmitting the plurality of server identifiers comprises transmitting representations of the server identifiers for storage in a cookie at the client.

38. The method of claim 29, wherein each server identifier comprises an encoded IP address.

39. A method for storing session state information in a multiple server architecture, comprising:
receiving an initial request from a client;
directing the initial request to a first server within a plurality of servers;
creating a session for the client;
storing the client session at a storage device associated with the first server;
storing, at at least one additional storage device associated with at least one additional server, a copy of the client session;
transmitting, to the client, a plurality of server identifiers, the server identifiers identifying the first server and the at least one additional server as the holders of the session.

40. The method of claim 39, wherein:
directing the initial request to a first server within a plurality of servers comprises directing the initial request using at least one of a load balancing method based on network conditions and a round robin allocation method.

41. The method of claim 39, wherein the plurality of servers comprises a grid.

42. The method of claim 39, wherein transmitting the plurality of server identifiers comprises transmitting representations of the server identifiers for storage in a cookie at the client.

43. The method of claim 39, wherein each server identifier comprises an encoded IP address.

44. A method for retrieving session state information in a multiple server architecture, comprising:
receiving a request from a client, the request comprising a plurality of server identifiers identifying a plurality of servers as holders of a session;
directing the request to a server;
at the server, reading the plurality of server identifiers; and
responding to the request using a session stored at one of the identified servers.

45. The method of claim 44, wherein responding to the request using the session comprises:
the server retrieving the session from one of the identified servers.

46. The method of claim 45, further comprising:
storing the client session at a storage device associated with the server; and
storing, at at least one additional storage device associated with at least one additional server, a copy of the client session;
transmitting, to the client, server identifiers identifying the server and the at least one additional server as the holders of the session.

47. The method of claim 44, wherein responding to the request using the stored session comprises:
redirecting the request to a server identified by one of the server identifiers.

48. The method of claim 44, wherein responding to the request using the stored session comprises:
determining whether to retrieve the session from a server identified by one of the server identifiers or to redirect the subsequent request to a server identified by one of the server identifiers; and
performing the determined action.

49. The method of claim 48, wherein determining whether to retrieve or redirect comprises determining whether the session size exceeds the request size.

50. The method of claim 44, wherein:
directing the request to a server comprises directing the request using at least one of a load balancing method based on network conditions and a round robin allocation method.

51. The method of claim 44, wherein the plurality of servers comprises a grid.

52. The method of claim 44, wherein each server identifier comprises an encoded IP address.

53. A computer program product for maintaining session state information in a multiple server architecture, comprising:
a computer-readable medium; and
computer program code, encoded on the medium, for:
receiving an initial request from a client;
directing the initial request to a first server within a plurality of servers;
creating a session for the client;
storing the client session at a storage device associated with the first server;
transmitting, to the client, a server identifier identifying the first server as the holder of the session;
receiving a subsequent request from the client, the subsequent request comprising the server identifier identifying the first server;
directing the subsequent request to a second server within a plurality of servers;
at the second server, reading the server identifier; and
responding to the request using the session stored at the server identified by the server identifier.

54. A computer program product for maintaining session state information in a multiple server architecture, comprising:
a computer-readable medium; and
computer program code, encoded on the medium, for:
receiving an initial request from a client;
directing the initial request to a first server within a plurality of servers;
creating a session for the client;
storing the client session at a storage device associated with the first server;
storing a copy of the client session at at least one additional storage device associated with at least one additional server;
transmitting, to the client, a plurality of server identifiers, the server identifiers identifying the first server and the at least one additional server as the holders of the session;
receiving a subsequent request from the client, the subsequent request comprising the server identifiers identifying the first server and the at least one additional server;
directing the subsequent request to a second server within the plurality of servers;
at the second server, reading the server identifiers; and
responding to the request using the session stored at a server identified by one of the server identifiers.

55. A system for maintaining session state information in a multiple server architecture, comprising:
a load balancer, for:
receiving an initial request from a client and directing the initial request to a first server within a plurality of servers; and
receiving a subsequent request from the client, the subsequent request comprising the server identifier identifying the first server and directing the subsequent request to a second server within a plurality of servers;
a first server, for creating a session for the client and for transmitting, to the client, a server identifier identifying the first server as the holder of the session;
a storage device associated with the first server, for storing the client session; and
a second server, for reading the server identifier and responding to the request using the session stored at the first server.

56. A system for maintaining session state information in a multiple server architecture, comprising:
a load balancer, for:
receiving an initial request from a client and directing the initial request to a first server within a plurality of servers; and
receiving a subsequent request from the client, the subsequent request comprising the server identifiers identifying the first server and the at least one additional server and directing the subsequent request to a second server within the plurality of servers;
a first server, for creating a session for the client and for transmitting, to the client, a plurality of server identifiers, the server identifiers identifying the first server and at least one additional server as the holders of the session;
a storage device associated with the first server, for storing the client session;
at least one additional storage device associated with at least one additional server, for storing a copy of the client session; and
a second server for reading the server identifiers responding to the request using the session stored at a server identified by one of the server identifiers.
